(19) United States
(12) Patent Application Publication
(10) Pub. No.: US 2010/0008523 A1
(43) Pub. Date: Jan. 14, 2010

(54) Handheld Devices Including Selectively Enabled Audio Transducers

(75) Inventors: Randolph Cary Demuynck, Wake Forest, NC (US); Charles C. Hunt, Wake Forest, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB, Lund (SE)

(21) Appl. No.: 12/172,427

(22) Filed: Jul. 14, 2008

(51) Int. Cl. H04R 1/00

(52) U.S. Cl. 381/182

(57) ABSTRACT

A handheld electronic device, such as mobile terminal, PDA or media player, includes a housing and a plurality of audio transducers supported by the housing and positioned at spaced-apart positions. The device further includes an audio circuit configured to change an allocation of audio transmission and/or reception functions among the plurality of audio transducers responsive to a user's mechanical interaction with the device, e.g., responsive to a change in an attitude at which a user is holding the housing and/or a change in a position of a moveable component of the device, such as a moveable display.

### FIELD OF THE INVENTION

The present invention relates to handheld electronic devices and, more particularly, to handheld electronic devices with audio capabilities.

### BACKGROUND OF THE INVENTION

Consumers may now select from a wide array of handheld electronic devices, such as cellular mobile terminals, personal digital assistants (PDAs) and media players. Such devices typically provide audio and/or video user interfaces. For example, a mobile terminal may include a display, keypad, speaker and microphone, which together support telephony functions. These components may also support multimedia, gaming and other applications.

Producers of such devices constantly strive to provide new audio and visual interfaces to enhance user experience and, thus, gainer greater market share. Thus, for example, handheld devices have been provided with touchscreen displays that allow for user scrolling and other inputs, and display generators that use accelerometer inputs to adaptively orient an image to adjust for the attitude at which the device is being held. Some devices include multi-speaker audio systems that can provide a “surround sound” user experience.

### SUMMARY OF THE INVENTION

In some embodiments of the present invention, a handheld electronic device, such as mobile terminal, PDA or media player, includes a housing and a plurality of audio transducers supported by the housing and positioned at spaced-apart positions. The device further includes an audio circuit supported by the housing and configured to change an allocation of audio transmission and/or reception functions among the plurality of audio transducers responsive to a user's mechanical interaction with the device. For example, in some embodiments, the device includes a sensor circuit (e.g., a gravitational sensor such as an accelerometer) configured to detect a change in an attitude at which a user is holding the housing, and the audio circuit is configured to change an allocation of audio transmission and/or reception functions among the plurality of audio transducers responsive to the detected change in the attitude.

In further embodiments, the device includes a sensor circuit configured to detect a change in a relative positioning of a moveable component of the electronic device, such as a moveable display, and the audio circuit is configured to change an allocation of audio transmission and/or reception functions among the plurality of audio transducers responsive to the detected change in relative positioning of the moveable component. The device may include, for example, first and second displays fixed in or deployable to a side-by-side arrangement, with the moveable display being a third display configured to variably overlap the first and second displays. The third display may be moveable to a position bridging the first and second displays to support display of a composite image of a single scene across the first, second and third displays, and the plurality of audio transducers may include first and second speakers positioned on respective opposite sides of the composite image. The audio circuit may be configured to activate both of the first and second speakers responsive to the sensor detecting movement of the third display to the position bridging the first and second displays to support, for example, stereo or surround sound effects.

In additional embodiments of the present invention, a handheld electronic device includes a housing and first and second audio transducers supported by the housing and positioned at respective first and second spaced apart positions that interchangeably serve as mouthpiece and earpiece positions when the housing is held at first and second attitudes. The device further includes an attitude sensor circuit supported by the housing and configured to detect an attitude at which a user is holding the housing and a user interface controller circuit operatively associated with the attitude sensor circuit and configured to selectively allocate audio transmission and/or reception functions among the plurality of audio transducers responsive to the detected attitude. The device may further include a display supported by the housing and configured to display images at a face thereof. The user interface controller circuit may be configured to orient images on the display responsive to the detected attitude. The first and second audio transducers may be positioned on respective first and second sides of the display. The first and second audio transducers may include respective pairs of transducers, each pair of transducers including a speaker and a microphone.

Additional embodiments of the present invention provide methods of operating a handheld electronic device including a housing and a plurality of audio transducers supported by the housing and positioned at spaced-apart positions. A user's mechanical interaction with the device and an allocation of audio transmission and/or reception functions among the plurality of audio transducers is changed responsive to the detected mechanical interaction. The detected mechanical interaction may include, for example, a change in an attitude at which a user is holding the housing and/or a change in a relative positioning of a moveable component of the electronic device. The electronic device may further include a display supported by the housing and configured to display images at a face thereof and images on the display may be oriented responsive to the detected mechanical interaction.

### BRIEF DESCRIPTION OF THE DRAWINGS

FIG. 1 is a schematic diagram illustrating a handheld electronic device with adaptive audio configuration capabilities according to some embodiments of the present invention.

FIG. 2 is a diagram illustrating a handheld electronic device with a display and selectively enabled audio transducers according to further embodiments of the present invention.

FIG. 3 is a schematic diagram illustrating control circuitry for the electronic device of FIG. 2.

FIGS. 4A-4C illustrate exemplary operations of the electronic device of FIG. 2.

FIG. 5 illustrates a mobile terminal with selectively enabled audio transducers according to further embodiments of the present invention.

FIGS. 6A-6C illustrates exemplary operations of the electronic device of FIG. 5.

FIG. 7 illustrates control of allocation of audio functions among audio transducers according to display position according to further embodiments of the present invention.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Some embodiments are described with regard to flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Some embodiments of the present invention provide mobile terminals or other handheld electronic devices that have spaced-apart audio transducers that may be selectively enabled to support, for example, different usage scenarios. For example, in mobile terminal applications, respective speaker/microphone pairs may be positioned at respective ends to support use of the terminal for telephony in two different handheld positions. Such speakers/microphones may also be used to support surround sound in, for example, multimedia applications. Transmission and/or reception functions may be allocated among the audio transducers responsive to, for example, sensing an attitude at which a user is holding the device, a mechanical configuration of the device or some other mechanical interaction with the device.

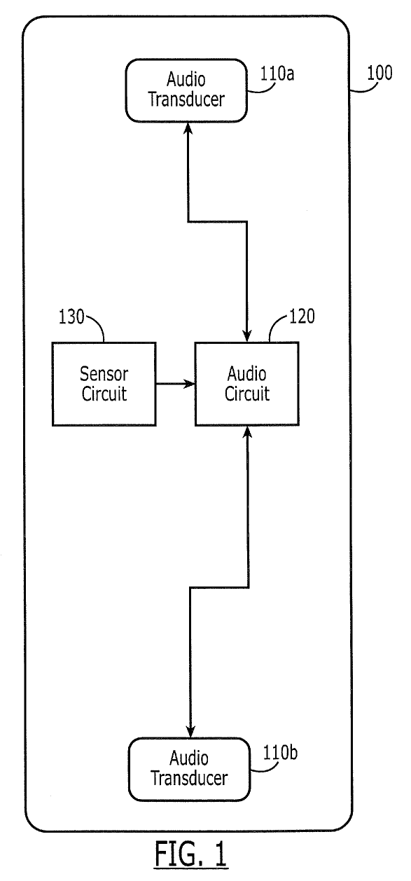

FIG. 1 illustrates a handheld electronic device 100 according to some embodiments of the present invention. The electronic device 100 includes at least two spaced-apart audio transducers 110a, 110b controlled by an audio circuit 120. The audio transducers 110a, 110b each may include one or more types of transducers, including, but not limited to, speakers, microphones and dual-purpose transducers capable of transmitting and receiving audio signals. Responsive to a sensor signal provided by a sensor circuit 130, the audio circuit 120 selectively enables and/or disables the audio transducers 110a, 110b such that, for example, an allocation of audio transmission and/or reception functions among the transducers 110a, 110b is changed, e.g., swapped, upon detection of a mechanical interaction of a user with the electronic device 100. For example, in some embodiments, the sensor circuit 130 may include an accelerometer or other circuitry capable of detecting a change in attitude at which the device 100 is deployed such that, for example, if a user inverts the device 100, the audio circuit 120 swaps speaker and microphone functions of the audio transducers 110a, 110b. In other embodiments, the sensor circuit 130 may sense a change in a physical configuration of a constituent component of the device 100 and the audio circuit 120 may responsively reallocate transmission and/or reception functions among the audio transducers 110a, 110b.

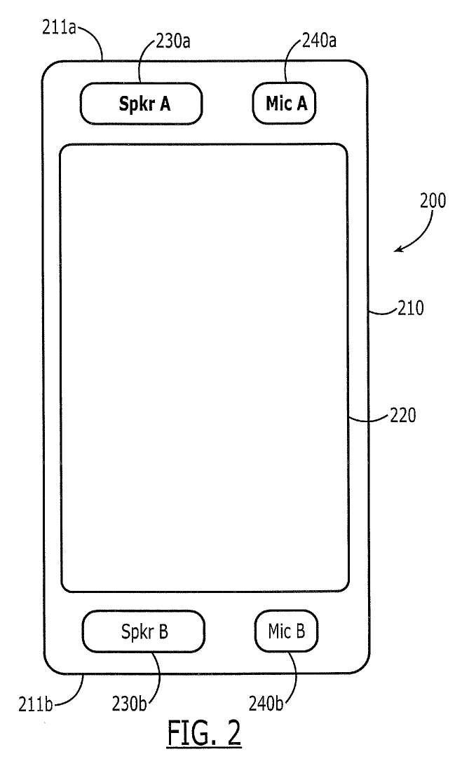

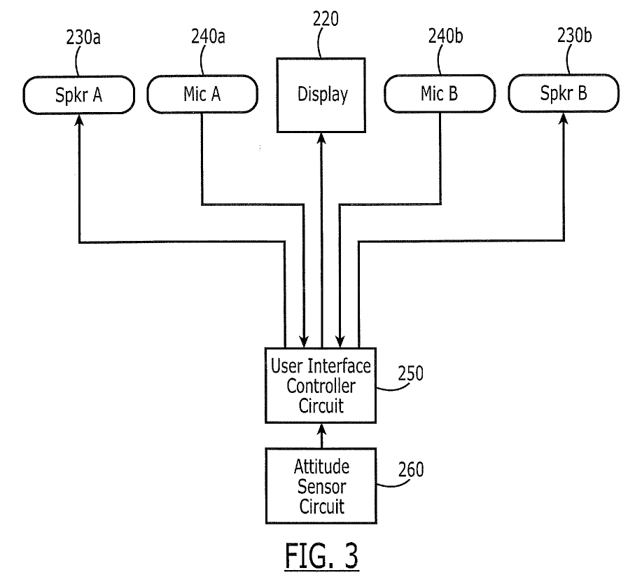

FIG. 2 illustrates an electronic device 200 according to further embodiments of the present invention. The device 200 (e.g., a mobile terminal, personal digital assistant, media player or the like) includes a housing 210 that supports a display 220. Respective pairs of audio transducers, each including a speaker 230a, 230b and microphone 240a, 240b, are positioned proximate respective ends 211a, 211b of the housing 210. Due to symmetry of the housing 210, the ends 211a, 211b may interchangeably serve as mouthpiece and earpiece positions for use of the device as a handset. As illustrated in FIG. 3, the device 200 may include a user interface controller circuit 250, which controls the display 220, speakers 230a, 230b and microphones 240a, 240b responsive to an attitude sensor signal generated by an attitude sensor circuit 260 (e.g., an accelerometer). It will be appreciated that the user interface controller circuit 250 may, in general, be implemented any of a variety of different analog and/or digital circuits, for example, using a microprocessor or microcontroller and peripheral circuitry.

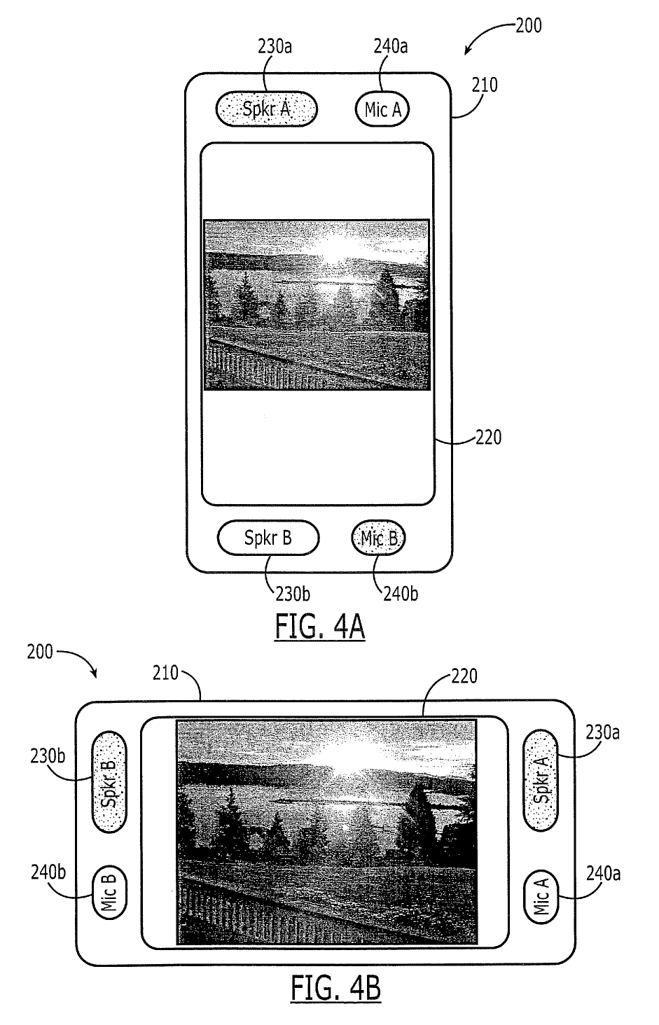

FIGS. 4A-4C illustrate exemplary operations of the electronic device 200 of FIGS. 2 and 3. In a first attitude, a first speaker 230a at one end of the device 200 and a first microphone 240b at a second end of the device 200 are activated, consistent with a portrait orientation of the display 220, such that a user normally would tend to place the active speaker 230a near his or her ear and place the active microphone 240b near his or her mouth to, for example, answer a telephone call. Referring to FIG. 4B, after the user has placed the device 200 in a horizontal position for use of, for example, a video or other multimedia application, the user interface controller circuit 250 reorients the display 220 to a landscape mode and activates both speakers 230a, 230b. In this configuration, the speakers 230a, 230b may be used, for example, to generate “surround sound” or other enhanced audio effects. In this mode, the user interface controller circuit 250 may deactivate both microphones 240a, 240b. Referring to FIG. 4C, the device 200 may be further rotated so that it is inverted with respect to the orientation in FIG. 4A. In this case, the user interface controller circuit 250 rotates the display 220 to a portrait mode, and activates the (now) upper speaker 230b and (now) lower microphone 240a.

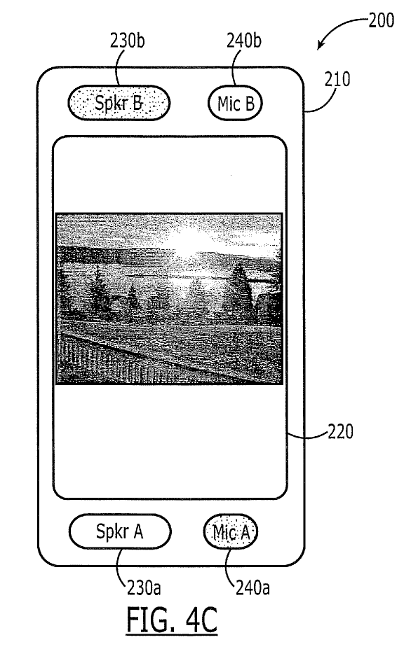

FIG. 5 illustrates an electronic device according to further embodiments of the present invention, in particular, a clamshell mobile terminal 500 including a set of displays including a moveable, overlapping display 530c that may be moved in relation to fixed displays 530a, 530b to support a variety of different display options. The fixed displays 530a, 530b are positioned on respective clamshell housing portions 510a, 520b that are joined by a hinge 520. The moveable display 530c is configured to slide across the fixed displays 530a, 530b when the device is in an open position, as explained in copending U.S. patent application Ser. No. ______ (Attorney Docket No. PU080191US1/9314-204), filed concurrently herewith and incorporated by reference herein in its entirety. Respective speaker/microphone pairs 540a, 550a, 540b, 550b are positioned proximate respective ends of the mobile terminal 500.

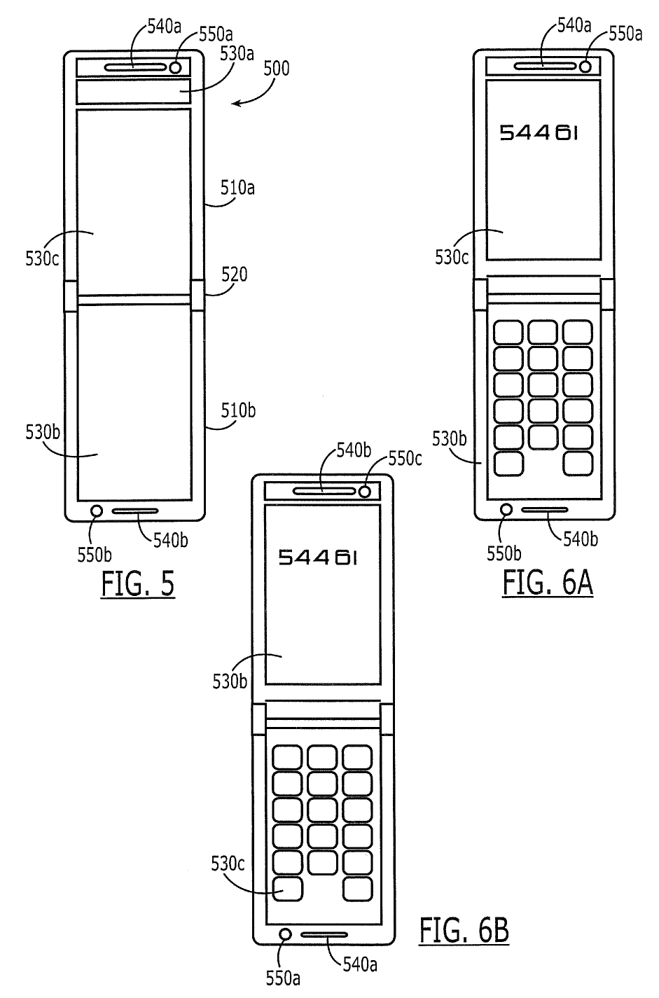

Referring to FIG. 6A, when the mobile terminal 500 is in at a first attitude with the moveable display 530c overlapping the fixed display 530a, the moveable display 530c and the unobstructed fixed display 530b display a telephone user interface including an informational image and a keypad image, respectively, each in a portrait alignment. In this arrangement, the top speaker 540a and the bottom microphone 550b are active, consistent with the telephone user interface displayed on the displays 530b, 530c. Referring to FIG. 6B, if inversion of the mobile terminal 500 is sensed (e.g., by an internal accelerometer) the images displayed on the displays 530b, 530c are swapped, and the (now) upper speaker 540b and (now) lower microphone 550a are activated. Referring to FIG. 6C, the mobile terminal 500 may be rotated to a landscape position, with the moveable display 530c moved to a center position that supports a widescreen display mode in which the three displays 530a, 530b, 530c display components of a composite image. In this configuration, control circuitry of the mobile terminal 500 may activate both speakers 540a, 540b to support surround sound and other effects. Such activation may occur responsive to, for example, attitude detection using an accelerometer or similar sensor, along lines described above.

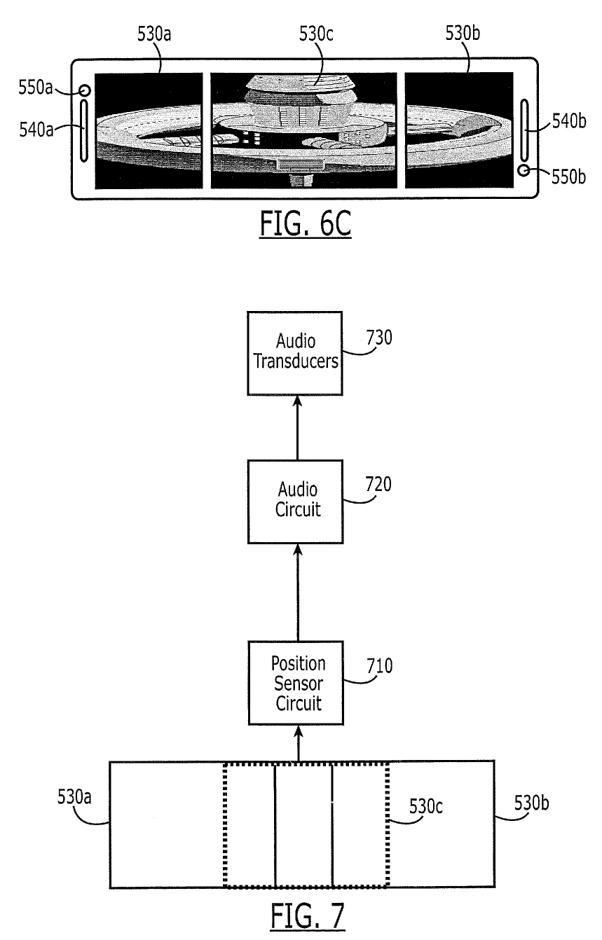

In further embodiments, allocation of audio transmission and/or reception functions among a plurality of spaced-apart audio transducers may occur responsive to detecting movement of the moveable display 530c to the centered position overlapping the other displays 530a, 530b. For example, as illustrated in FIG. 7, a position sensor 710 may be configured to detect movement of the moveable display 530c in relation to fixed displays 530a, 530b. As explained in the aforementioned U.S. patent application Ser. No. ______ (Attorney Docket No. PU080191US1/9314-204), such movement may be detected using any of a variety of different types of sensors, such as contacts, potentiometer, capacitive sensors or magnetic sensors. An audio circuit 720 may allocate audio transmission and/or reception functions among a plurality of audio transducers 730 responsive to an output of the position sensor 710.

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A handheld electronic device comprising:
a housing;
a plurality of audio transducers supported by the housing and positioned at spaced-apart positions; and
an audio circuit supported by the housing and configured to change an allocation of audio transmission and/or reception functions among the plurality of audio transducers responsive to a user's mechanical interaction with the device.

2. The device of claim 1, further comprising a sensor circuit supported by the housing and configured to detect a change in an attitude at which a user is holding the housing and wherein the audio circuit is operatively associated with the sensor circuit and configured to change an allocation of audio transmission and/or reception functions among the plurality of audio transducers responsive to the detected change in the attitude.

3. The device of claim 2, wherein the sensor circuit comprises a gravitational sensor.

4. The device of claim 1, further comprising a sensor circuit supported by the housing and configured to detect a change in a relative positioning of a moveable component of the electronic device and wherein the audio circuit is operatively associated with the sensor circuit and configured to change an allocation of audio transmission and/or reception functions among the plurality of audio transducers responsive to the detected change in relative positioning of the moveable component.

5. The device of claim 4, wherein the movable component comprises a moveable display supported by the housing, wherein the sensor is configured to detect movement of the moveable display and wherein the audio circuit is configured to change the allocation of audio transmission and/or reception functions among the plurality of audio transducers responsive to the detected movement of the moveable display.

6. The device of claim 5, further comprising first and second displays fixed in or deployable to a side-by-side arrangement, wherein the moveable display comprises a third display configured to variably overlap the first and second displays, wherein the third display is moveable to a position bridging the first and second displays to support display of a composite image of a single scene across the first, second and third displays, wherein the plurality of audio transducers comprises first and second speakers positioned on respective opposite sides of the composite image, and wherein audio circuit is configured to activate both of the first and second speakers responsive to the sensor detecting movement of the third display to the position bridging the first and second displays.

7. The device of claim 1, further comprising a display supported by the housing and configured to display images at a face thereof and a display controller circuit configured to orient images on the display responsive to the detected mechanical interaction.

8. The device of claim 1, wherein the plurality of audio transducers comprise respective pairs of transducers, each pair of transducers comprising a speaker and a microphone.

9. The device of claim 1:
wherein the housing is arranged in or deployable to an elongate form having first and second ends; and
wherein the plurality of audio transducers comprise first and second audio transducers positioned proximate respective ones of the first and second ends.

10. A handheld electronic device comprising:
a housing;
first and second audio transducers supported by the housing and positioned at respective first and second spaced apart positions that interchangeably serve as mouthpiece and earpiece positions when the housing is held at first and second attitudes;
an attitude sensor circuit supported by the housing and configured to detect an attitude at which a user is holding the housing; and
a user interface controller circuit operatively associated with the attitude sensor circuit and configured to selectively allocate audio transmission and/or reception functions among the plurality of audio transducers responsive to the detected attitude.

11. The device of claim 10, further comprising a display supported by the housing and configured to display images at a face thereof and wherein the user interface controller circuit is configured to orient images on the display responsive to the detected attitude.

12. The device of claim 11, wherein the first and second audio transducers are positioned on respective first and second sides of the display.

13. The device of claim 10, wherein the housing is arranged in or deployable to an elongate form having first and second ends and wherein the first and second audio transducers are positioned proximate respective ones of the first and second ends.

14. The device of claim 10, wherein the first and second audio transducers comprise respective pairs of transducers, each pair of transducers comprising a speaker and a microphone.

15. A method of operating a handheld electronic device comprising a housing and a plurality of audio transducers supported by the housing and positioned at spaced-apart positions, the method comprising:
detecting a user's mechanical interaction with the device; and
changing an allocation of audio transmission and/or reception functions among the plurality of audio transducers responsive to the detected mechanical interaction.

16. The method of claim 15, wherein detecting a mechanical user interaction with the device comprises detecting a change in an attitude at which a user is holding the housing.

17. The method of claim 15, wherein detecting a mechanical user interaction with the device comprises detecting a change in a relative positioning of a moveable component of the electronic device.

18. The method of claim 17, wherein detecting a change in a relative positioning of a moveable component of the electronic device comprises detecting a change in a position of a moveable display of the electronic device.

19. The method of claim 15, wherein the electronic device further comprises a display supported by the housing and configured to display images at a face thereof and wherein the method comprises orienting images on the display responsive to the detected mechanical interaction.
